(19) United States
(12) Patent Application Publication
(10) Pub. No.: US 2023/0077238 A1
(43) Pub. Date: Mar. 9, 2023

(54) METHOD AND SYSTEM FOR GENERATING SITE SURVEY INFORMATION

(71) Applicant: Hamina Wireless Oy, Helsinki (FI)

(72) Inventor: Jussi Kiviniemi, Espoo (FI)

(73) Assignee: Hamina Wireless Oy, Helsinki (FI)

(21) Appl. No.: 17/466,055

(22) Filed: Sep. 3, 2021

(51) Int. Cl. H04W 24/08; H04W 76/10; H04W 24/02; H04W 16/18

(52) U.S. Cl. CPC H04W 24/08; H04W 76/10; H04W 24/02; H04W 16/18

(57) ABSTRACT

Disclosed is method for generating site survey information pertaining to radio network. The method includes forming communication session using first communication channel between wireless site-survey device(s) and communication radio of first wireless access point configuring first wireless access point to monitor radio packets being transmitted by wireless site-survey device(s) using at least one of communication radio or monitoring radio of first wireless access point, configuring second wireless access point to monitor radio packets being transmitted by wireless site-survey device(s) using monitoring radio of second wireless access point, collecting first set of site-survey data recorded by first and second wireless access points, and processing the collected first set of site-survey data to generate site survey information pertaining to the radio network.

### TECHNICAL FIELD

The present disclosure relates to methods for generating site survey information pertaining to radio networks. Moreover, the present disclosure also relates to systems for wireless site surveying.

### BACKGROUND

An essential activity while designing and deploying a wireless network for an enterprise is conducting a wireless site survey for validating the wireless network's coverage, reliability, and performance on-site. Typically, to perform the wireless site survey, a surveyor walks around the entire site while mapping out wireless signals to obtain passive survey measurements. Upon performing the wireless site survey, there may be generated, for example, a heat map depicting network coverage as measured by the surveyor in multiple locations within the site. Traditionally, performing the wireless site survey requires specialized wireless measurement hardware to be carried by the surveyor for obtaining passive survey measurements

Requiring such specialized hardware, or special configurations of such specialized hardware limits the number of surveyors who are able to perform wireless site surveys, thereby increasing costs associated with said survey, as well as requiring people who own specialized hardware to either travel on-site themselves, or to ship the specialized gear to the site. Generally, the specialized wireless measurement hardware is expensive, complicated to set up and may be inconvenient to carry around the site for long durations. When the specialized wireless measurement hardware runs on batteries, such hardware is also challenging to recharge. Moreover, the existing wireless measurement hardware sets up limitations for a speed at which the network can be surveyed, since the wireless measurement hardware is required to cycle through multiple channels used by wireless access points for surveying. Therefore, greater the number of channels, lesser is the speed of surveying. Furthermore, the existing wireless measurement hardware also measures network packets as sent by access point, and as received by said measurement hardware. In this way, the wireless measurement hardware often creates an overly-optimistic view of the wireless network since access points often transmit the network packets at higher power levels than what the wireless measurement hardware can transmit back at.

Therefore, in light of the foregoing discussion, there exists a need to overcome the aforementioned drawbacks associated with techniques and equipment for wireless site surveying.

### SUMMARY

The present disclosure seeks to provide a method for generating site survey information pertaining to a radio network. The present disclosure also seeks to provide a system for wireless site surveying. An aim of the present disclosure is to provide a solution that overcomes at least partially the problems encountered in prior art.

In one aspect, an embodiment of the present disclosure provides a method for generating site survey information pertaining to a radio network, the radio network comprising at least a first wireless access point and a second wireless access point, the method comprising:
forming a communication session, using a first communication channel, between at least one wireless site-survey device and a communication radio of the first wireless access point;
configuring the first wireless access point to monitor radio packets being transmitted by the at least one wireless site-survey device on the first communication channel during the communication session, using at least one of the communication radio or a monitoring radio of the first wireless access point;
configuring the second wireless access point to monitor the radio packets being transmitted by the at least one wireless site-survey device on the first communication channel during the communication session, using a monitoring radio of the second wireless access point;
collecting, from the first wireless access point and the second wireless access point, a first set of site-survey data recorded by the first wireless access point and the second wireless access point, respectively, pertaining to the monitored radio packets; and
processing the collected first set of site-survey data to generate site survey information pertaining to the radio network.

In another aspect, an embodiment of the present disclosure provides a system for wireless site surveying, the system comprising:
at least one wireless site-survey device comprising a communication radio for communicating over a plurality of different communication channels;
two or more wireless access points communicably connected to a wireless network controller and to a calculation unit, each of the two or more wireless access points having a monitoring radio;
the wireless network controller configured to provide instructions to the two or more wireless access points to monitor radio packets being transmitted by the at least one wireless site-survey device on a given communication channel; and
the calculation unit configured to collect a given set of site-survey data from the two or more wireless access points and to process the given set of site-survey data to generate site survey information.

Embodiments of the present disclosure substantially eliminate or at least partially address the aforementioned problems in the prior art, and enable accurate and quick wireless site surveying without requiring any specialised hardware.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for generating site survey information, in accordance with an embodiment of the present disclosure;

FIG. 2 is a schematic of a system for wireless surveying, in accordance with an embodiment of the present disclosure;

FIG. 3 is an architecture of a system for wireless surveying, in accordance with an embodiment of the present disclosure;

FIG. 4 is an exemplary implementation of a system for wireless surveying at a site, in accordance with an embodiment of the present disclosure;

FIG. 5 is a first exemplary process flow implemented by a system for wireless surveying, in accordance with an embodiment of the present disclosure;

FIG. 6 is a schematic depicting a relative spatial arrangement of a first wireless access point and a second access point with three exemplary spatial locations of a wireless site-survey device, in accordance with an embodiment of the present disclosure; and

FIG. 7 is a second exemplary process flow implemented by a system for wireless surveying, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for generating site survey information pertaining to a radio network, the radio network comprising at least a first wireless access point and a second wireless access point, the method comprising:
forming a communication session, using a first communication channel, between at least one wireless site-survey device and a communication radio of the first wireless access point;
configuring the first wireless access point to monitor radio packets being transmitted by the at least one wireless site-survey device on the first communication channel during the communication session, using at least one of the communication radio or a monitoring radio of the first wireless access point;
configuring the second wireless access point to monitor the radio packets being transmitted by the at least one wireless site-survey device on the first communication channel during the communication session, using a monitoring radio of the second wireless access point;
collecting, from the first wireless access point and the second wireless access point, a first set of site-survey data recorded by the first wireless access point and the second wireless access point, respectively, pertaining to the monitored radio packets; and
processing the collected first set of site-survey data to generate site survey information pertaining to the radio network.

In another aspect, an embodiment of the present disclosure provides a system for wireless site surveying, the system comprising:
at least one wireless site-survey device comprising a communication radio for communicating over a plurality of different communication channels;
two or more wireless access points communicably connected to a wireless network controller and to a calculation unit, each of the two or more wireless access points having a monitoring radio;
the wireless network controller configured to provide instructions to the two or more wireless access points to monitor radio packets being transmitted by the at least one wireless site-survey device on a given communication channel; and
the calculation unit configured to collect a given set of site-survey data from the two or more wireless access points and to process the given set of site-survey data to generate site survey information.

The present disclosure provides the aforementioned method and the aforementioned system. The method and the system enable quick and accurate generation of the site survey information by performing simultaneous multiple measurements related to the site survey. Moreover, by moving the at least one wireless site-survey device, the first set of site-survey data is recorded from the first wireless access point and the second wireless access point, from various spatial locations in the site. Furthermore, the first set of site-survey data is recorded at the same time, by the first and second wireless access points, from a given communication channel. This is different from prior techniques in which measurements are done only from one wireless access point at a time. An amount of time needed for generating the site survey information according to the method described herein is about 50% of an amount of time needed by the prior techniques, when two wireless access points are present in the radio network. Similarly, if the radio network includes ten wireless access points, the amount of time needed for generating the site survey information according to the present method is reduced to 1/10th of the amount of time needed by the prior techniques. Beneficially, a single communication from the at least one wireless site-survey device is used by two or more wireless access points to form the first set of site-survey data, thereby enabling faster generation of the site survey information. Thus, with the present method and the system, at least one additional access point other than a given wireless access point monitors communication for obtaining information of the site. In practice, there can be several other like 5, 10, 100 wireless access points all of which monitors a given communication channel when the given wireless access point is communicating. Also, a technical effect of monitoring with the wireless access points is that no special software is needed on the at least one wireless site-survey device.

The present disclosure relates to the method and the system for generating site survey information pertaining to the radio network. Herein, the site survey information may be values, graphical representation, heat map, tabular representation, and the like, of at least one parameter related to the radio network. It may be appreciated that the radio network is a communication network that employs radio waves for communication. The radio network may be employed in cell phones, satellite communication, wireless networking and the like. When the radio network is established (i.e., set up) in the site, the site is surveyed to generate the site survey information. Examples of the site include, but are not limited to, schools, offices, industrial plants, shopping centres, recreation areas, and open areas. The surveying of the site may determine on-site radio network speeds, uplink and downlink performances, signal strengths, optimum communication channels to be used, possible coverage gaps and the like, as a function of a site area and spatial locations. For example, during the setting up of the radio network, the site may be surveyed to generate the site survey information to check whether the radio network has been set up properly or not. Similarly, when the radio network that is already set up in the site exhibits any issues, such as low signal strength, the site may be surveyed to generate the site survey information for determining an extent of these issues and may facilitate in identifying reasons causing the aforesaid issues.

The radio network comprises at least the first wireless access point and the second wireless access point. The radio network optionally comprises additional wireless access points, such as a third wireless access point, a fourth wireless access point, and so forth. It may be contemplated that a given wireless access point (WAP) is a device that allows wireless devices, such as, a mobile phone, laptop, tablet, and the like, to connect to a network through a wireless standard. The given wireless access point, along with the wireless devices may form the radio network. The network may, for example, be a local area network, such as Ethernet.

In an embodiment, the first wireless access point and the second wireless access point are managed by the wireless network controller. The wireless network controller may typically set up and/or manage at least one communication channel that is used between the first and second wireless access points and the at least one wireless site-survey device. Typically, each wireless access point may be connected (either wirelessly and/or in a wired manner) via the network to the wireless network controller and to appropriate proxies, routers or firewalls to implement the radio network. The wireless network controller is optionally embedded in each wireless access point. In some embodiments, a wireless network administrator may perform and/or supervise management, monitoring, maintenance, configuration, and the like, of the radio network. Typically, the wireless network administrator may access the wireless network controller, any of the wireless access points and the calculation unit either directly, or using an administrator communication device. It may be noted that the radio network comprising the first wireless access point and the second wireless access point of the present disclosure may be able to operate in a wireless site-survey mode which has been explained in the succeeding paragraphs. Implementing the wireless site-survey mode for the radio network may need minor extra functionality to be developed both on the wireless access points (radio devices) and the wireless network controller, for the control and management of the radio network.

It will be appreciated that a given wireless site-survey device is any mobile computing device such as a smartphone, a tablet, the laptop and the like that is able to wirelessly connect to the radio network. As an example, any Wi-Fi enabled mobile device compliant with 802.11 standards with respect to client-access point communication may be used as the at least one wireless site-survey device. Optionally, the at least one wireless site-survey device has a means for positioning it in respect to locations of the wireless access points, such as the first wireless access point and the second wireless access point, or in respect to the site where the radio network is implemented. One example of means for positioning is using in satellite navigation system if the site survey is conducted outside. In case of conducting the site survey inside indoor positioning systems such as triangulation to wireless access points can be done. Further example is providing a map in user interface and asking for person conducting the survey to point in the map which room the user is at a given point of time. The at least one wireless site-survey device may connect to any of the wireless access points such as, the first wireless access point and the second wireless access point according to its reach (i.e., wireless range), to form a connection thereto. Furthermore, optionally, the at least one wireless site-survey device is communicably coupled with the calculation unit, wherein the calculation unit is configured to execute a measurement back-end software. The calculation unit may be for example, a back-end server, cloud server, a module of wireless network controller, and the like.

The method comprises forming the communication session, using the first communication channel, between the at least one wireless site-survey device and the communication radio of the first wireless access point. The radio network facilitates communication over the at least one communication channel. In an exemplary embodiment, the radio network may include a first communication band of 2.4 Ghz and a second communication band of 5 GHz. In said communication bands the at least one wireless site-survey device can communicate in a dedicated communication channel(s). As an example 2.4 Ghz communication band can comprise 11 channels each allotted 20 MHz of bandwidth and separated by 5 Mhz. Since the 2.4 Ghz band is 100 MHz wide some of the 11 channels will overlap and interfere with each others. One of the reasons of making site survey is to find setup in which interference is eliminated at least partially. Herein, upon establishing the communication session, a two-way communication may be enabled between the at least one wireless site-survey device and the first wireless access point. This communication may include sending and receiving radio packets between the at least one wireless site-survey device and the communication radio of the first wireless access point.

The method further comprises configuring the first wireless access point to monitor radio packets being transmitted by the at least one wireless site-survey device on the first communication channel during the communication session, using at least one of the communication radio or the monitoring radio of the first wireless access point. The monitoring radio may enable one-way communication, wherein the first wireless access point may only listen to (i.e., receive) the radio packets being sent from the at least one wireless site-survey device on the first communication channel. Therefore, a given monitoring radio enables monitoring of the radio packets being sent over a given communication channel. The given monitoring radio may be normally operated in receive only mode (RX). The role of the given monitoring radio in a given wireless access point may be to report findings, measurements, and the like, to the given wireless access point.

Optionally, the monitoring radio is one of: a dedicated monitoring radio of a given wireless access point, a repurposed communication radio of the given wireless access point. In this regard the dedicated monitoring radio may only listen to radio packets being communicated via the given communication channel. The repurposed communication radio may be configured to switch between a functionality of the communication radio and a functionality of the dedicated monitoring radio according to a purpose for which the given wireless access point needs to be operated. That is, in some instances, the communication radio may be repurposed to also perform the functionality of the monitoring radio. In an embodiment, the wireless network controller may be configured to dynamically repurpose a given communication radio to be operated as the monitoring radio or the communication radio, as required.

The method further comprises configuring the second wireless access point to monitor the radio packets being transmitted by the at least one wireless site-survey device on the first communication channel during the communication session, using the monitoring radio of the second wireless access point. Herein, the monitoring radio of the second wireless access point is tuned to the first communication channel in order to synchronously listen and receive the radio packets being communicated over the first communication channel during the communication session. As an example if communication band is 2.4 GHz the first communication channel can be channel 1 of said band. In practice channel 1 of 2.4 GHz band is band between 2401-2423 MHz. It will be noted that without the wireless site-survey mode, just the first wireless access point that happens to be communicating on the first communication channel (and a fraction of other access points that just happened to be on the same channel) would be able to “hear” the at least one wireless site-survey device. The extra measurements received by the second wireless access point may allow, for example, creation of comprehensive, high quality heat maps of signal coverage and other signal metric of the radio network, without needing any extra measurement hardware and is based on just one quick walk/drive around the site. Thus, the first set of site-survey data received may be of high quality and taken by professional-quality radios of enterprise-grade. A frequency of measurements received may be ten-fold and quicker compared to handheld measurement equipment, or other techniques of generating the site survey information.

The method further comprises collecting, from the first wireless access point and the second wireless access point, the first set of site-survey data recorded by the first wireless access point and the second wireless access point, respectively, pertaining to the monitored radio packets. In an embodiment, the first set of site-survey data may be collected by the calculation unit directly. In an alternative embodiment, the first set of site-survey data may be collected by the calculation unit via the wireless network controller. In such an embodiment, the first wireless access point and the second wireless access point sends the first set of site-survey data to the wireless network controller. The term wireless network controller can refer to dedicated hardware or it can refer to a software running for example in cloud or an server. It will be appreciated that such collecting can be performed during the communication session and/or after the communication session. The first set of site-survey data is collected in order for it to be processed to generate the site survey information. Indeed technical effect of the method is that one or more monitoring radios can monitor the communication at the same time and thus forming a set of data fast. Furthermore since the data is collected simultaneously the data represents true situation at a given location. If data would be collected base station per base station then the movement of the wireless site-survey device could have negative impact on collected data. Now each data set (from two or more bases stations) represent exactly the same location.

Optionally, the first set of site-survey data pertains to at least one of: signal strength, signal-to-noise ratio, number of lost packets, packet retry, information about sending the same packet repeatedly, wireless data rates, wireless modulation, noise level, packet header, spectrum analysis measurements. In this regard, the signal strength may refer to an amount of radio frequency energy that is received by a given radio (i.e., a given communication radio and/or a given monitoring radio). Depending on the spatial location of the at least one wireless site-survey device with respect to the first wireless access point and the second wireless access point, the signal strength may vary. Closer the at least one wireless site-survey device with respect to the first wireless access point and/or the second wireless access point, greater will be the signal strength, and vice versa. The signal-to-noise ratio may refer to a ratio of signal power to a noise power in a radio signal received by the given radio. Information about sending the same packet repeatedly may refer to a number of times the same packet is sent. Packet retry may refer to at least one of: a number of times, a time duration, a reason, of resending a given radio packet, when the given radio packet is sent formerly but fails to be received. As an example, a first test radio packet may be sent when the communication session is established and then it may be checked whether the first test radio packet is delivered or not. Wireless data rates may refer to a rate at which the radio packets are transferred between the at least one wireless site-survey device and the given wireless access point. The wireless modulation may refer to a type of modulation such as, an amplitude modulation, a frequency modulation, and the like, that is used on a radio signal being communicated over the given communication channel. The noise level may be measured in decibels and may indicate an amount of noise present in the radio signal. A high noise level may degrade radio packets being sent in the radio signal. The packet header may include protocol information and address of a source (which may be the at least one wireless site-survey device) and a destination (which may be the first wireless access point or the second wireless access point) of a given radio packet. The spectrum analysis measurements may refer to a full or partial spectrum sweep over the frequency, resulting in a graph of received signal power (amplitude) over multiple, often hundreds of measurement points over the measured frequency space. As discussed, the first set of site-survey data may pertain to at least one of the parameters described above.

It may be noted that in the wireless site-survey mode, each of the first and second wireless access points would be tuned to the same communication channel that the at least one wireless site-survey device is connected to. In an example, when the at least one wireless site-survey device is using a first communication channel ‘40’ then the communication radio or the monitoring radio of the first wireless access point and the monitoring radio of the second wireless access point are both tuned to the said communication channel, and may therefore listen to communication on the first communication channel 40. The first wireless access point and the second wireless access point may optionally be further configured to provide the first set of site-survey data (obtained using received radio packets) over the first communication channel 40 to the calculation unit. It will be appreciated that the given wireless access point is capable of communicating over the at least one communication channel. In some implementations, the given wireless access point is capable of communicating over a single communication channel, while in other implementations, the given wireless access point is capable of communicating over a plurality of communication channels.

Optionally, other parameters such as metadata, physical data and the signal strength related to the radio packets communicated over the given communication channel may be provided to the calculation unit together with data (such as payload data, header data, and similar) captured by radios of the first and second wireless access points. Such data may be a part of the first set of site-survey data. In this way, the first wireless access point and the second wireless access point may receive in synchronization, the radio packets from the at least one wireless site-survey device and may use that together with meta data such as received signal strength to form the first set of site-survey data and provide the first set of site-survey data for analysis to the calculation unit.

The method further comprises processing the collected first set of site-survey data to generate site survey information pertaining to the radio network. In an embodiment, the collected first set of site-survey data may be processed to generate the heat map related to the radio network on the site. It may be appreciated that the heat map may represent the signal strength throughout the site. For example, areas in the site that have good signal strength, average signal strength and poor signal strength may be represented with green, yellow and red colors respectively, in the heat map. In an alternative embodiment, the collected first set of site-survey data may be processed to generate at least one of: a histogram, a table, a pie chart, of the collected first set of site-survey data. It will be appreciated that the collected first set of site-survey data may be processed to generate the site survey information in any required form. Optionally, the collected first set of site-survey data is processed using at least one data processing algorithm to generate the site survey information. Examples of the at least one data processing algorithm include, but are not limited to, a data sorting algorithm, a data representation algorithm, a data interpretation algorithm, and a data filtering algorithm.

As discussed, when the radio network is in the wireless site-survey mode, the first wireless access point and the second wireless access point near the at least one wireless site-survey device may continuously listen to all the radio packets and signal information related to the at least one wireless site-survey device. In one instance, two communication channels namely, the first communication channel and the second communication channel are used for facilitating the communication over the radio network. Herein, the first communication channel and the second communication channel may be selected autonomously by each wireless access point or those can be set by the wireless network controller. Given wireless access point advertise their presence on their operating channel and the at least one wireless site-survey device forms communication on the advertised channel. Typically nearby wireless access points operate on different channels to minimize co-channel interference. Typically the wireless site-survey device listens to said advertisements emanating from all wireless access points on all channels, and will tune to one based on for example signal strength reading (picks the strongest one). As an example, the communication session may be formed, using the second communication channel, between at least one wireless site-survey device and the communication radio of the first wireless access point. Next, in this example, the first wireless access point may monitor radio packets transmitted by the at least one wireless site-survey device on the second communication channel using at least one of: the communication radio or the monitoring radio of the first wireless access point. The second wireless access point may monitor the radio packets transmitted by the at least one wireless site-survey device on the second communication channel using the monitoring radio of the second wireless access point. Thereafter, the first set of site-survey data may be collected and be processed to update the generated site survey information pertaining to the radio network. Furthermore, the wireless network controller can be used to command the first wireless access point to operate at arbitrary channel. A nearby wireless site-survey device will tune in said arbitrary channel. Based on the embodiments the second wireless access point is configured to listen the same arbitrary channel as used to communicate with the wireless site-survey device. In this way, the wireless network controller may efficiently switch (or force switch), by changing communication channel of the first wireless access point from one channel to an other, a given wireless site-survey device to switch from one communication channel to another, for enabling fast scanning of each communication channel of the radio network. According to one alternative embodiment there can be optional software in the at least one wireless site-survey device which forces it to use certain channel. This might be beneficial during the site survey to find possible causes for interference for example.

Optionally, the method further comprises:
configuring the at least one wireless site-survey device to transmit radio packets on a second communication channel during the communication session, the second communication channel being different from the first communication channel;
configuring the first wireless access point to monitor the radio packets being transmitted by the at least one wireless site-survey device on the second communication channel, using the monitoring radio of the first wireless access point;
configuring the second wireless access point to monitor the radio packets being transmitted by the at least one wireless site-survey device on the second communication channel, using at least one of a communication radio of the second wireless access point or the monitoring radio of the second wireless access point;
collecting, from the first wireless access point and the second wireless access point, a second set of site-survey data recorded by the first wireless access point and the second wireless access point, respectively, pertaining to said monitored radio packets; and
processing the collected second set of site-survey data to update the site survey information pertaining to the radio network.

In this regard, the at least one wireless site-survey device changes its communication from one communication channel to another communication channel as it roams from one wireless access point to another. This “configuring the at least one wireless site-survey device to transmit radio packets on a second communication channel” can be implemented by configuring the monitoring radio of the first wireless access point to change its channel from the first communication channel to the second communication channel. With this type of reconfiguration of the first wireless access point it is possible to continuously listen for wireless packets on the current operating channel of the site survey device on, in an efficient way, at each given spatial location.

Indeed in the present embodiment, the at least one wireless site-survey device is configured to transit radio packets on the second communication channel. This may be configured either automatically (as per selecting suitable channel by the at least one wireless site-survey device) or via the wireless network controller in case there is special purpose software installed in the at least one wireless site-survey device which forces the at least wireless site-survey device to transmit radio packets on the second communication channel during the communication session. Next, both the first wireless access point and the second wireless access point may monitor by at least listening to the radio packets transmitted by the at least one wireless site-survey device on the second communication channel. Herein, the second communication channel may form the two-way communication with the second wireless access point and the one-way communication with the first wireless access point. Hence, the first wireless access point may only listen and receive the radio packets transmitted by the at least one wireless site-survey device on the second communication channel. Finally, the second set of site-survey data is collected and processed, to update the site survey information which was earlier generated using the first set of site-survey data.

It may be noted that the communication session refers to a session of communication, using the measurements of which the site survey information is generated. The communication session may comprise a first sub session and a second sub session. During the first sub session, the first communication channel may be used for communicating, whereas during the second sub session, the second communication channel may be used for communicating.

Optionally, the method further comprises
determining a spatial location of the at least one wireless site-survey device while the first set of site-survey data is being collected; and
mapping information pertaining to the determined spatial location with the first set of site-survey data when generating the site survey information.

In this regard, it may be appreciated that surveying of the site may map at least one of the parameters pertaining to the first set of site-survey data with the spatial location in order to check values of the aforesaid parameters at each spatial location on the site. These parameters vary across different spatial locations in the site, and therefore it is beneficial to generate location-specific site survey information. For example, when the site in which the radio network is implemented has a first area having the first wireless access point, a second area having the second wireless access point and the third area having a third wireless access point, and the at least one wireless site-survey device is spatially located in the second area, the signal strength received by the second access point would be greater as compared to signal strengths received by the first access point and the third access point. As the at least one wireless site-survey device is moved over to the third area, the signal strength received by the third wireless access point would be greater than the signal strengths received by the first wireless access point and the second wireless access point. Subsequently, location-specific signal strength data may be generated, wherein such data accurately indicates how signal strengths vary spatially for each wireless access point in the site.

Optionally, the at least one wireless site-survey device has a locating means for providing the spatial location. The locating means may be an automatic locating means such as an indoor location system. Additionally, or alternatively, optionally, the spatial location of the at least one wireless site-survey device is provided as input by a user of the at least one wireless site-survey device. As an example, the user input may be such as, “I'm in room 1”. The spatial location may be provided to the calculation unit to form the location-specific site survey information of the radio network. The spatial location may be also measured using wireless access points and signal strengths when spatial locations of the wireless access points and a manner in which signal strength varies on going away from a given wireless access point are known in sufficient detail.

Optionally, the spatial location of the at least one wireless site-survey device is determined by at least one of:
using triangulation on signal data collected from the two or more wireless access points,
a location sensor of the at least one wireless site-survey device.

In this regard, it may be appreciated that triangulation involves determination of the spatial location of the at least one wireless site survey device using spatial locations of the two or more wireless access points and the signal data collected by the two or more wireless access points, by employing laws of trigonometry. The location sensor may be a device that determines the spatial location of the at least one wireless site-survey device. As an example, the location sensor may be implemented as a camera, a Bluetooth-based sensor, an infrared sensor, a magnetic sensor, and the like. Further optionally the spatial locations of the site-survey device is obtained by means of measuring received signal strengths with given wireless access points, wherein location errors emanating from an error in at least one of the received signal strength is compensated after detecting of the signal strength reception error. As an example if location is initially detected to be at equal distance from a first wireless access point and a second wireless access point (as both report same received signal strength from the at least one site-survey device) then location is deemed to be half way between the two wireless access points. However, if it later found out that the second wireless access point had, during the measurement, problem with antenna and thus received signal only ½ of normal strength the actual location would have been about ⅓ of the total distance to the first wireless access point and ⅔ of the total distance to the second wireless access point. This location and thus generated site survey information can be compensated using after detecting the error.

Optionally, the site survey information is created using multiple sets of data received from multiple spatial locations. Herein, the multiple sets of data received from a given spatial location is indicative of the at least one parameter for multiple channels at the given spatial location. Herein, the at least one wireless site-survey device may be moved to various spatial locations (such as the first area, the second area and the third area) within the site, and the radio packets received by the first wireless access point and the second wireless access point when the at least one wireless site-survey device is positioned at each spatial location may be used to collect the multiple sets of data from the multiple spatial locations for generating the site survey information. The site survey information may be a comprehensive information created using measurements of the at least one parameter of each channel for each spatial location.

Optionally, the method further comprises:
configuring the at least one wireless site-survey device to measure network-related data;
collecting the measured network-related data from the at least one wireless site-survey device; and
processing the measured network-related data to update the site survey information pertaining to the radio network.

In this regard, the network-related data may be the at least one parameter. The at least one wireless site-survey device may measure the network-related data using a field measurement software. The field measurement software executes on the at least one wireless site-survey device, or on a cloud-based device, wherein the field measurement software facilitates in surveying the site. Herein, the field measurement software may be a software tool capable of requesting for the wireless site-survey mode to be turned on or off, and of indicating metadata about measurements made by it (for example, by way of metadata associated with the spatial locations on a map of the site). The field measurement software may also perform its own radio network tests using data captured by a wireless radio residing on the at least one wireless site-survey device. For example, the field measurement software such as, an application for measuring signal strength may perform a small test to measure signal strength at a given spatial location of a given wireless site-survey device. The measured network-related data from the at least one wireless site-survey device may be collected by the calculation unit either directly or via the wireless network controller for processing. Accordingly, the site survey information pertaining to the radio network may be updated. For example, when a signal strength measured by the first wireless access point is −40 dBm and a signal strength measured by the at least one wireless site-survey device is −45 dBm, a value of a signal strength in the site survey information may be updated to −45 dBm. In an embodiment, a value of a given parameter may be updated according to weights assigned to values measured by the at least one wireless site-survey device and the wireless access point. That is, if in the aforesaid example, the at least one wireless site-survey device is more reliable than the first wireless access point, the weight assigned to the at least one wireless site-survey device may be greater than the weight of the first wireless access point, and the value of the updated signal strength may be a weighted sum of signal strengths. In another embodiment, the value may be updated by taking mean, median or mode of the values obtained from the at least one wireless site-survey device and the first wireless access point or the second wireless access point. An other example of measurement can comprise taking streaming connection (a voice or video) to between the at least one wireless site-survey device and a test server. In said streaming connection one can monitor latency, jitter, quality of service etc. For example the at least one wireless site-survey device can connect to a video service in Internet and perform streaming tests.

Optionally, the site survey information is provided to at least one of:
a wireless network controller employed to configure radio network parameters of at least one of: the first wireless access point, the second wireless access point,
a database for storing the site survey information for access by a user.

In this regard, the wireless network controller may utilize the site survey information to control and manage the radio network. In an embodiment, the wireless network controller utilizes the site survey information to configure the at least one parameter of the radio network and/or parameters of at least one of: the first wireless access point and the second wireless access point. For example, when the site survey information indicates that the signal strength provided by the first wireless access point is consistently low, the wireless network controller may adjust the at least one parameter of the radio network in order to increase the signal strength provided by the first wireless access point. That is, the wireless network controller may beneficially work as a correcting means to improve the signal strength of the first wireless access point. In another embodiment, the site survey information is systematically stored in the database, to facilitate quick access (namely, retrieval), updating and analysis of the site survey information. Herein, the database may be a computing technique for storing organized data (i.e., the site survey information) in a device such as, a computer, a laptop, a palmtop, a cloud server, and the like.

Optionally, the at least one wireless site-survey device comprises two or more wireless site-survey devices, wherein the two or more wireless site-survey devices perform simultaneous monitoring of the radio packets, each wireless site-survey device having a unique identifier. The unique identifier may be a unique ID given to each wireless site-survey device to distinguish each wireless site-survey device from other wireless site-survey devices. The unique identifier may be in form of one or more of: an alphabetic code, a numeric code, a symbolic code, and the like. Herein, the use of two or more wireless site-survey devices may help in generating site survey information faster (as said devices can survey the site more quickly than a single wireless site-survey device) and more accurately (as said devices yield a more comprehensive set of site-survey data). In some embodiments, each wireless site-survey device may provide their unique identifier to the calculation unit together with a first request to start site survey. The calculation unit may provide the unique identifier and the first request to the wireless network controller. The wireless network controller may optionally provide a second request to a communication terminal of the wireless network administrator to allow turning the radio network to the wireless site-survey mode. Alternatively, the wireless network controller may be given permission to implement the wireless site-survey mode without additional requests from the wireless network administrator. As a further example there can be two site survey devices both communicating on different channels. Monitoring radios of wireless access points are then configured to listen either simultaneously said different channels or in time division basis (1 sec for the first channel and then 1 sec for the second channel for example).

Moreover, the present description also relates to the system for wireless site surveying as described above. The various embodiments and variants disclosed above apply mutatis mutandis to the system.

Optionally, the monitoring radio is one of: a dedicated monitoring radio of: a given wireless access point, a repurposed communication radio of the given wireless access point.

Optionally, the system is configured to determine a spatial location of the at least one wireless site-survey device while the given set of site-survey data is being collected and map information pertaining to the determined spatial location with the given set of site-survey data when generating the site survey information.

Optionally, the spatial location of the at least one wireless site-survey device is determined by at least one of:
using triangulation on signal data collected from the two or more wireless access points,
a location sensor of the at least one wireless site-survey device.

The method and the system may be used in a large number of applications. Firstly, the method and the system may be used to validate the radio network after it has been built in order to document the coverage, performance, reliability and other metrics of the radio network by generating the site survey information. Secondly, the method and the system may be used for troubleshooting purposes. Thirdly, the method and the system may be used for measuring parameters of the radio network to understand the existing radio network, existing building materials and their attenuation, before building a new and improved radio network. Fourthly, one or more wireless access points of the present disclosure may be also used for measuring an attenuation due to wall materials at the site, for accurately designing a high-quality radio network.

### DETAILED DESCRIPTION OF THE DRAWINGS

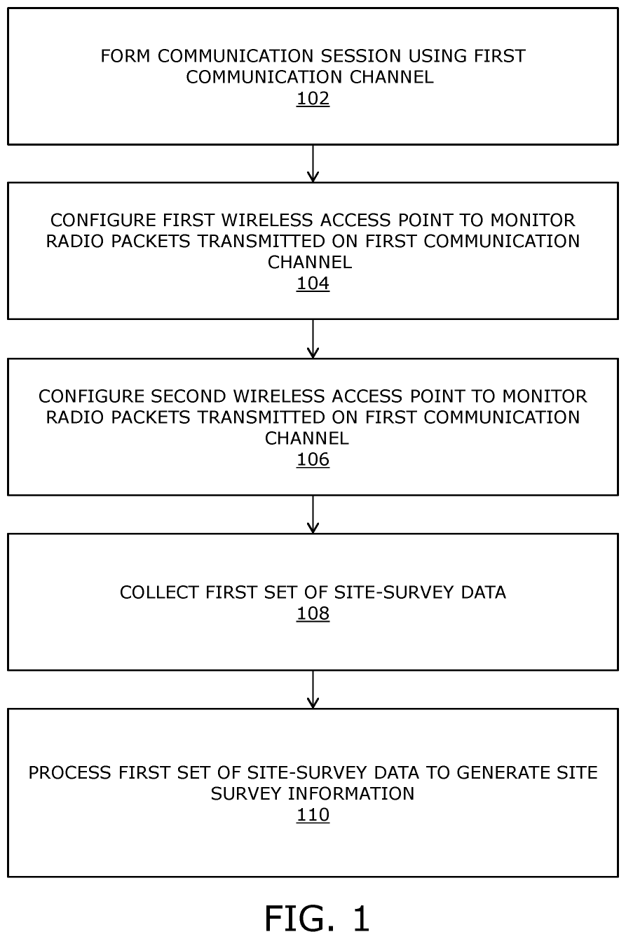

Referring to FIG. 1, illustrated is a flowchart depicting steps of a method for generating site survey information, in accordance with an embodiment of the present disclosure. At step 102, a communication session is formed, using a first communication channel, between at least one wireless site-survey device and a communication radio of the first wireless access point. At step 104, the first wireless access point is configured to monitor radio packets being transmitted by the at least one wireless site-survey device on the first communication channel during the communication session, using at least one of the communication radio or a monitoring radio of the first wireless access point. At step 106, the second wireless access point is configured to monitor the radio packets being transmitted by the at least one wireless site-survey device on the first communication channel during the communication session, using a monitoring radio of the second wireless access point. At step 108, a first set of site-survey data recorded by the first wireless access point and the second wireless access point is collected from the first wireless access point and the second wireless access point, respectively, pertaining to the monitored radio packets. At step 110, the collected first set of site-survey data is processed to generate site survey information pertaining to the radio network.

The steps 102, 104, 106, 108 and 110 are only illustrative and other alternatives can also be provided where one or more steps are added, one or more steps are removed, or one or more steps are provided in a different sequence without departing from the scope of the claims herein.

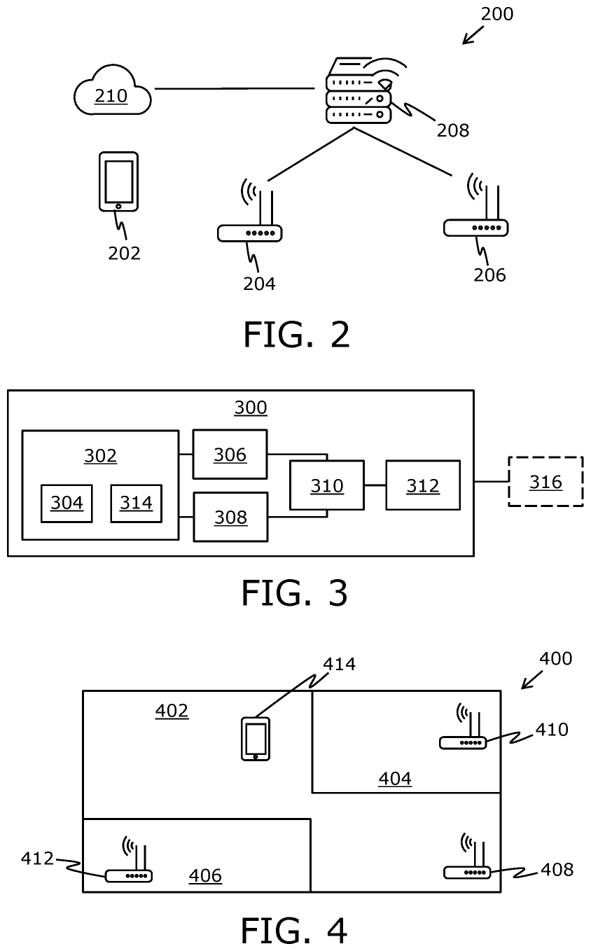

Referring to FIG. 2, illustrated is a schematic of a system 200 for wireless surveying, in accordance with an embodiment of the present disclosure. The system 200 for wireless surveying comprises at least one wireless site-survey device (depicted as a wireless site-survey device 202), two or more wireless access points (depicted as wireless access points 204 and 206), a wireless network controller 208 and a calculation unit 210. The two wireless access points 204 and 206 are communicably coupled to the wireless site-survey device 202, the wireless network controller 208, and the calculation unit 210. The calculation unit 210 may, for example, be a cloud server (as shown).

Referring to FIG. 3, illustrated is an architecture of a system 300 for wireless surveying, in accordance with an embodiment of the present disclosure. The system 300 for wireless surveying comprises at least one wireless site-survey device (depicted as a wireless site-survey device 302) comprising a communication radio (depicted as a communication radio 304) for communicating over a plurality of different communication channels, two or more wireless access points (depicted as two wireless access points 306 and 308), a wireless network controller 310, and a calculation unit 312. The two wireless access points 306 and 308 are communicably coupled to the wireless network controller 310 and the calculation unit 312. The wireless site-survey device 302 optionally also comprises a location sensor 314. Site survey information generated by the system 300 is optionally provided to a database 316.

Referring to FIG. 4, illustrated is an exemplary implementation of a system for wireless surveying at a site 400, in accordance with an embodiment of the present disclosure. The site 400 is divided into a first area 402, a second area 404 and a third area 406. The first area 402 comprises a first wireless access point 408, the second area 404 comprises a second wireless access point 410 and the third area 406 comprises a third wireless access point 412. When a wireless site-survey device 414 is moved through the site 400, the wireless site-survey device 414 connects to an appropriate wireless access point, depending on a spatial location of the wireless site-survey device 414 within the site 400. As an example, when the wireless site-survey device 414 is in the first area 402, the wireless site-survey device 414 may connect with the first wireless access point 408; when the wireless site-survey device 414 is in the second area 404, the wireless site-survey device 414 may connect with the second wireless access point 410; and when the wireless site-survey device 414 is in the third area 406, the wireless site-survey device 414 may connect with the third wireless access point 412.

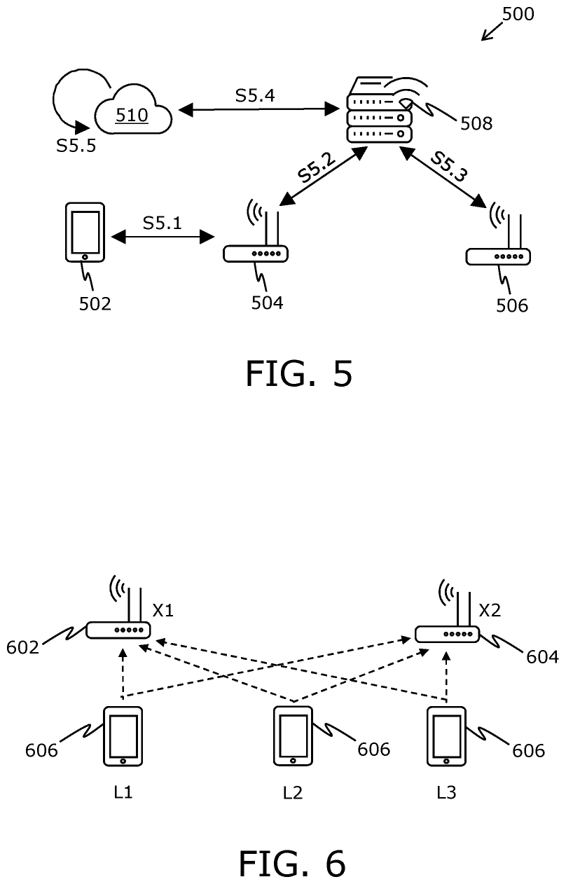

Referring to FIG. 5, illustrated is a first exemplary process flow implemented by a system for wireless surveying, in accordance with an embodiment of the present disclosure. At step S5.1, a wireless site-survey device 502 forms a communication session with a first wireless access point 504. At step S5.2, the first wireless access point 504 monitors radio packets being transmitted by the wireless site-survey device 502, and communicates the monitored radio packets to a wireless network controller 508. At step S5.3, a second wireless access point 506 monitors radio packets being transmitted by the wireless site-survey device 502, and communicates the monitored radio packets to the wireless network controller 508. At step S5.4, a first set of site-survey data pertaining to the monitored radio packets, recorded by the first wireless access point and the second wireless access point, is collected by the wireless network controller 508 and is communicated to a calculation unit 510 by the wireless network controller 508. At step S5.5, the collected first set of site-survey data is processed, by the calculation unit 510, to generate site survey information.

Referring to FIG. 6, illustrated is a schematic depicting a relative spatial arrangement of a first wireless access point 602 and a second wireless access point 604 with three exemplary spatial locations L1, L2, and L3 of a wireless site-survey device 606, in accordance with an embodiment of the present disclosure. Herein, the first wireless access point 602 and the second access point 604 are located at different spatial locations X1 and X2 within a site (not shown), and the wireless site-survey device 606 is moved within the site to the three exemplary spatial locations L1, L2, and L3. Notably, signal strength received by a given wireless access point from the wireless site-survey device 606 varies inversely with a distance (indicated as dashed arrows) between the given wireless access point and the wireless site-survey device 606. As an example, when the wireless site-survey device 606 is at the spatial location L1, signal strength received by the first wireless access point 602 is higher than signal strength received by the second access point 604; when the wireless site-survey device 606 is at the spatial location L2, the signal strength received by the first wireless access point 602 is equal to the signal strength received by the second access point 604; and when the wireless site-survey device 606 is at the spatial location L3, the signal strength received by the first wireless access point 602 is lower than the signal strength received by the second access point 604.

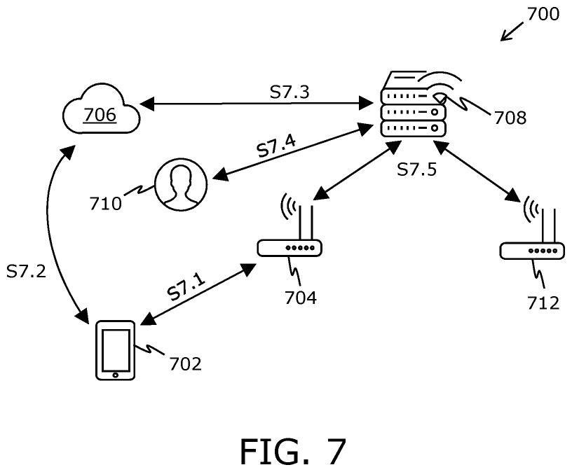

Referring to FIG. 7, illustrated is a second exemplary process flow implemented by a system for wireless surveying, in accordance with an embodiment of the present disclosure. At step S7.1, a wireless site-survey device 702 connects with a first wireless access point 704. At step S7.2, the wireless site-survey device 702 communicates with a calculation unit 706, wherein the wireless site-survey device 702 provides its unique identifier to the calculation unit 706 for authentication of its identity, along with a request to start site survey. At step S7.3, the calculation unit 706 provides the unique identifier of the wireless site-survey device 702 and the request to a wireless network controller 708. At step S7.4, the wireless network controller 708 optionally provides the request to a wireless network administrator 710 for operating the network in a wireless site survey mode. At step S7.5, the wireless network controller 708 sends a configuration message to both the first wireless access point 704 and a second wireless access point 712, in order to switch their operation to the wireless site survey mode.

Indeed a benefit of the present disclosure is that communication between the at least one wireless site-survey device and a first wireless access point can be monitored using a second wireless access point at the same time. This way compressive collection of site survey information and data can be made from multiple access points' point of view simulatenously. Furthermore since eventually the at least one site survey device will roam from one access point to another wireless access point (and thus will likely change its operation from the first channel to a second channel). The benefit of this present disclosure is that even after this “roaming”, the network performance and coverage can continuously continue to be measured by means of configuration of the monitoring radios on the fly. Indeed, in essence, in real time.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for generating site survey information pertaining to a radio network, the radio network comprising at least a first wireless access point and a second wireless access point, the method comprising:
forming a communication session, using a first communication channel, between at least one wireless site-survey device and a communication radio of the first wireless access point;
configuring the first wireless access point to monitor radio packets being transmitted by the at least one wireless site-survey device on the first communication channel during the communication session, using at least one of the communication radio or a monitoring radio of the first wireless access point;
configuring the second wireless access point to monitor the radio packets being transmitted by the at least one wireless site-survey device on the first communication channel during the communication session, using a monitoring radio of the second wireless access point;
collecting, from the first wireless access point and the second wireless access point, a first set of site-survey data recorded by the first wireless access point and the second wireless access point, respectively, pertaining to the monitored radio packets; and
processing the collected first set of site-survey data to generate site survey information pertaining to the radio network.

2. The method according to claim 1, wherein the method further comprises:
configuring the at least one wireless site-survey device to transmit radio packets on a second communication channel during the communication session, the second communication channel being different from the first communication channel;
configuring the first wireless access point to monitor the radio packets being transmitted by the at least one wireless site-survey device on the second communication channel, using the monitoring radio of the first wireless access point;
configuring the second wireless access point to monitor the radio packets being transmitted by the at least one wireless site-survey device on the second communication channel, using at least one of a communication radio of the second wireless access point or the monitoring radio of the second wireless access point;
collecting, from the first wireless access point and the second wireless access point, a second set of site-survey data recorded by the first wireless access point and the second wireless access point, respectively, pertaining to said monitored radio packets; and
processing the collected second set of site-survey data to update the site survey information pertaining to the radio network.

3. The method according to claim 1, wherein the first set of site-survey data pertains to at least one of: signal strength, signal-to-noise ratio, number of lost packets, packet retry, information about sending a same packet repeatedly, wireless data rates, wireless modulation, noise level, packet header, spectrum analysis measurements.

4. The method according to claim 1, wherein the method further comprises:
determining a spatial location of the at least one wireless site-survey device while the first set of site-survey data is being collected; and
mapping information pertaining to the determined spatial location with the first set of site-survey data when generating the site survey information.

5. The method according to claim 1, wherein the method further comprises:
configuring the at least one wireless site-survey device to measure network-related data;
collecting the measured network-related data from the at least one wireless site-survey device; and
processing the measured network-related data to update the site survey information pertaining to the radio network.

6. The method according to claim 1, wherein the site survey information is provided to at least one of:
a wireless network controller employed to configure radio network parameters of at least one of: the first wireless access point, the second wireless access point,
a database for storing the site survey information for access by a user.

7. The method according to claim 1, wherein the at least one wireless site-survey device comprises two or more wireless site-survey devices, wherein the two or more wireless site-survey devices perform simultaneous monitoring of the radio packets, each wireless site-survey device having a unique identifier.

8. The method according to claim 1, wherein the site survey information is created using multiple sets of data received from multiple spatial locations.

9. The method according to claim 1, wherein the monitoring radio is one of: a dedicated monitoring radio of a given wireless access point, a repurposed communication radio of the given wireless access point.

10. The method according to claim 8 wherein the spatial locations of the site-survey device is obtained by means of measuring received signal strengths with given wireless access points, wherein location errors emanating from an error in at least one of the received signal strength is compensated after detecting of the signal strength reception error.

11. A system for wireless site surveying, the system comprising:
at least one wireless site-survey device comprising a communication radio for communicating over a plurality of different communication channels;
two or more wireless access points communicably connected to a wireless network controller and to a calculation unit, each of the two or more wireless access points having a monitoring radio;
the wireless network controller configured to provide instructions to the two or more wireless access points to monitor radio packets being transmitted by the at least one wireless site-survey device on a given communication channel; and
the calculation unit configured to collect a given set of site-survey data from the two or more wireless access points and to process the given set of site-survey data to generate site survey information.

12. The system according to claim 11, wherein the monitoring radio is one of: a dedicated monitoring radio of a given wireless access point, a repurposed communication radio of the given wireless access point.

13. The system according to claim 11, wherein the system is configured to determine a spatial location of the at least one wireless site-survey device while the given set of site-survey data is being collected and map information pertaining to the determined spatial location with the given set of site-survey data when generating the site survey information.

14. The system according to claim 13, wherein the spatial location of the at least one wireless site-survey device is determined by at least one of:
using triangulation on signal data collected from the two or more wireless access points,
a location sensor of the at least one wireless site-survey device.
